(19) United States
(12) Patent Application Publication
(10) Pub. No.: US 2003/0152829 A1
(43) Pub. Date: Aug. 14, 2003

(54) Thin lithium film battery

(76) Inventors: Ji-Guang Zhang, Marietta, GA (US); Eleston Maxie JR., Kennesaw, GA (US)

Correspondence Address: Dorian B. Kennedy, Baker, Donelson, Bearman & Caldwell, Suite 900, Five Concourse Parkway, Atlanta, GA, 30328, US

(21) Appl. No.: 10/074,875

(22) Filed: Feb. 12, 2002

(51) Int. Cl. H01M 4/64; H01M 2/08; H01M 10/04

(52) U.S. Cl. 429/153; 429/162; 429/185; 429/233; 29/623.5

(57) ABSTRACT

A rechargeable, thin film lithium battery cell (10) is provided having a supporting substrate (11), a cathode current collector (12), a cathode (13), a solid state electrolyte (14), an anode (15) and an anode current collector (17). The battery cell (10) also has a ceramic protective layer (19) which covers the exposed or outwardly facing surfaces of the cathode (13), electrolyte (14), and anode (15) and at least a portion of the cathode and anode current collectors (12) and (17),

### TECHNICAL FIELD

This invention relates generally to thin film batteries, and more particularly to thin film, rechargeable lithium ion batteries having a protective packaging.

### BACKGROUND OF THE INVENTION

The metal lithium of thin film batteries reacts rapidly upon exposure to atmospheric elements such as oxygen, nitrogen, carbon dioxide and water vapor. Thus, the lithium ion or lithium metal anode and other air sensitive compounds of a thin film battery will react in an undesirable manner upon exposure to such elements if these components are not suitably protected. Other components of a thin film battery, such as a lithium electrolyte and cathode films, also require protection from exposure to air, although these components are commonly not as reactive as thin metal anode films. It should therefore be desirable to incorporate within a lithium battery, which includes an anode of lithium and other air sensitive components, a packaging system that satisfactorily protects the battery components from exposure to air.

Polymer batteries have been constructed in a manner in which the battery has an intermediary structure wherein a porous spacer exists between the anode and cathode. The partially constructed battery cell is then placed within a protective “bag” which is sealed along three edges. Once the battery cell is positioned within the bag a liquid electrolyte is poured into the bag to occupy the space within the porous spacer between the anode and cathode. The open edge or forth edge of the bag is then heat sealed, as shown in U.S. Pat. No. 6,187,472. During the last steps of this process however air or other gases occupy spaces within the bag. These gases are entrapped within the bag once it is sealed. Much care must also be exercised during the sealing process to insure that the heat seal does not contact the battery cell within the bag as the heat will harm the polymer battery cell.

In the past packaging systems for batteries have been devised which included a shield which overlays the active components of the battery, as shown in FIG. 1. These shields, which have been made of a ceramic material, a metallic material, and a combination of ceramic and metallic materials, are secured to the anode with an epoxy or polymer. As explained in U.S. Pat. No. 5,561,004 and shown in FIG. 1, batteries have been constructed wherein a base layer of parylene or epoxy is deposited upon the anode prior to the depositing of the ceramic, ceramic-metal combination, or parylene-metal combination protective shield. The parylene base layer however may cause leaching of atmospheric elements through the side edges of the parylene between the shield and the anode, as illustrated by the arrow labeled as gas path in FIG. 1. Also, as the shield is mounted with epoxy or the like unwanted and destructive gas pockets may be capture between the anode and the shield during construction.

Another thin film battery packaging system has been devised wherein alternating layers of parylene and titanium are laid over the active components. The alternating layers are provided to restrict the continuation of pin holes formed in the layers during construction. This method of producing a protective layer has been difficult to achieve and has provided a protective layer which remains effective for only a short time.

It thus is seen that a need remains for a packaging system for thin film batteries which overcomes problems associated with those of the prior art. Accordingly, it is to the provision of such that the present invention is primarily directed.

### SUMMARY OF THE INVENTION

In a preferred form of the invention, a thin film lithium battery comprises a supporting substrate, a stack of battery components mounted to the supporting substrate, the stack includes a cathode, an anode, and an electrolyte positioned between the cathode and anode, and a ceramic layer in intimate contact with and covering the outwardly facing surfaces of the stack.

In another preferred form of the invention, a method of manufacturing a lithium battery comprises the steps of (a) providing a supporting substrate; (b) depositing a stack of components upon the supporting substrate, the components including a cathode, an anode, and an electrolyte; and (c) depositing a ceramic layer directly upon the exposed surfaces of the stack of components.

### BRIEF DESCRIPTION OF THE DRAWINGS

FIG. 1 is a cross-sectional view of a thin film lithium battery of the prior art.

FIG. 2 is a plan view of a thin film lithium battery illustrating principles of the invention in a preferred embodiment.

FIG. 3 is a cross-sectional view of the thin film lithium battery of FIG. 2.

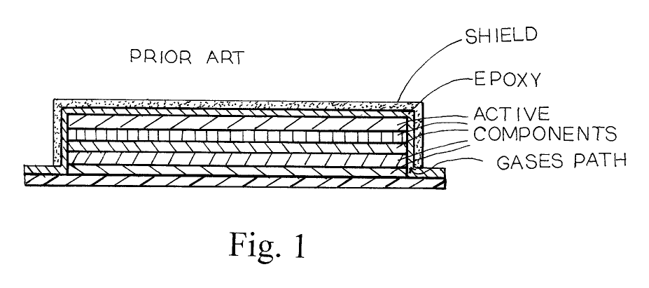

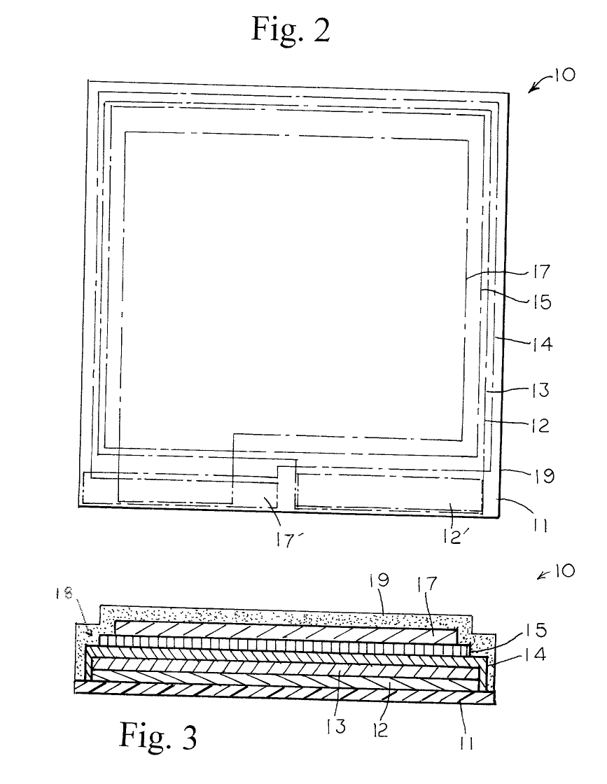

### DETAILED DESCRIPTION

With reference next to the drawings, there is shown in a rechargeable, thin film lithium battery cell 10 embodying principles of the invention in a preferred form. The battery cell 10 has a supporting substrate 11, a cathode current collector 12, a cathode 13, a solid state electrolyte 14, an anode 15 and an anode current collector 17. The cathode 13, electrolyte 14, anode 15 and a portion of the cathode current collector 12 and a portion of the anode current collector 17 may be referred to as a stack of battery components. The cathode current collector 12 includes a contact 12′ while the anode current collector 17 similarly includes a contact 17′.

The cathode 13 is made of a lithium intercalation compound, preferably a metal oxide such as LiNiO₂, V₂O₅, LiₓMn₂O₄, LiCoO₂ or TiS₂. The electrolyte 14 is preferable made of lithium phosphorus oxynitride, LiₓPO_{y}N_{z}. The anode is preferably made of silicon-tin oxynitride, SiTON, when used in lithium ion batteries, or other suitable materials such as lithium metal, zinc nitride or tin nitride. The cathode current collector 12 and anode current collector 17 is preferably made of copper or nickel.

The battery cell 10 also has a ceramic protective layer 19 which covers the exposed or outwardly facing surfaces of the cathode 13, electrolyte 14, and anode 15 and at least a portion of the cathode and anode current collectors 12 and 17, the exposed or outwardly facing surfaces being those surfaces which are not overlaid with another battery component, i.e. the side edges and the top surfaces of possibly some of the battery components depending upon the alignment of each successive component. Preferably the ceramic protective layer 19 is made of SiO₂, Si₃N₄, Al₂O₃ or other inorganic insulator layer. The construction and method of manufacturing the substrate, cathode current collector, cathode, electrolyte, anode and anode current collector are conventional, as shown in U.S. Pat. No. 5,561,004 which is specifically incorporated herein.

The ceramic protective layer 19 is sputter deposited directly onto the exposed areas of the battery stack so as to be in intimate contact with the top surface or surfaces of the stack, the side edges of the stack and the interior corners formed between the stack and the underlying substrate or current collector. The forming of the ceramic layer directly to the substrate or current collector provides a complete ceramic seal which prevents the migration of gases. This provides a significant improvement over the prior art wherein gas penetration along the side edges of the battery cannot be prevented because the exposed side edges of the parylene allows for leaching of gases over time. This problem is prevalent in the prior art even when a ceramic layer covers the battery components as a parylene layer is deposited prior to the ceramic layer thereby creating a layer of parylene between the ceramic and the substrate, the side edges of the parylene being exposed to ambience wherein gases may leach through the parylene layer over time.

The protective layer 19 may also include layers of metal or polymer in addition to the first base layer of ceramic. If this is desired, a polymer layer is placed over the ceramic layer to provide a smooth base upon which a metal coating is applied. The metal coating, which may be aluminum, may be 0.02 to 50 micrometers in depth. An additional, overlying layer of polymer may be deposited over the metal layer to protect the metal layer from scratching. Of course, it should be understood that this process may be repeated to provide multiple layers of metal and polymer for additional protection.

It should be understood that the anode layer may be formed at a later time upon the first charging of the battery, wherein lithium may be plated upon the anode current collector.

It should also be understood that the ceramic layer may extend from the cathode current collector in some portions rather than the substrate, as in where the cathode current collector extends beyond the side edges of the overlying cathode. However, the cathode current collector as used herein may be considered to be a portion of the substrate as it provides support and is impermeable to gases.

It should be understood that as an alternative to the sputtering of the ceramic that is shown in the preferred embodiment, other equivalent substitutes may be utilized to deposit the ceramic layer, such as vapor deposition, spray pyrolysis, laser ablation, chemical vapor deposition, PECVD, ion beam evaporation or other conventionally know methods.

Lastly, it should be understood that the battery components may be inverted so that the anode current collector is adjacent the substrate, with the anode thereon, the electrolyte upon the anode, the cathode upon the electrolyte and the cathode current collector upon the cathode.

It thus is seen that a battery is now provided having a protective packaging which completely seals the battery components from gases. It should of course be understood that many modifications may be made to the specific preferred embodiment described herein without departure from the spirit and scope of the invention as set forth in the following claims.

1. A thin film lithium battery comprising,
a supporting substrate;
a stack of battery components mounted to said supporting substrate, said stack including a cathode, an anode, and an electrolyte positioned between said cathode and said anode; and
a ceramic layer in intimate contact with and covering the outwardly facing surfaces of said stack.

2. The thin film lithium battery of claim 1 wherein said stack includes at least a portion of a current collector.

3. The thin film lithium battery of claim 2 wherein said current collector is an anode current collector.

4. A thin film lithium battery comprising,
a supporting substrate;
a cathode;
an anode;
an anode current collector;
an electrolyte positioned between said cathode and said anode; and
a ceramic layer in intimate contact with and extending from said substrate and to a position in intimate contact with and covering the exposed areas of cathode, anode and electrolyte above said substrate and at least a portion of said anode current collector.

5. The thin film lithium battery of claim 4 wherein said supporting substrate includes a current collector.

6. The thin film lithium battery of claim 4 wherein said current collector is a cathode current collector.

7. A method of manufacturing a lithium battery comprising the steps of:
(a) providing a supporting substrate;
(b) depositing a stack of components upon the supporting substrate, the stack of components including a cathode, an anode, and an electrolyte; and
(c) depositing a ceramic layer directly upon the exposed surfaces of the stack of components.

8. The method of claim 7 wherein the stack of components includes at least a portion of a current collector.

9. The thin film lithium battery of claim 8 wherein said current collector is an anode current collector

10. A method of manufacturing a lithium battery comprising the steps of:
(a) providing a supporting substrate;
(b) depositing a stack of components upon the supporting substrate, the components including a cathode, an anode and an electrolyte; and
(c) depositing a ceramic layer which extends from and in intimate contact with said supporting substrate to a position in intimate contact with and covering the outwardly facing surfaces of the stack of components.

11. The method of claim 10 wherein the stack of components includes at least a portion of a current collector.

12. The method of claim 11 wherein said current collector is an anode current collector.

13. The method of claim 10 wherein said supporting substrate includes a current collector.

14. The method of claim 13 wherein the current collector is a cathode current collector.
